(19) United States
(12) Patent Application Publication
(10) Pub. No.: US 2007/0205900 A1
(43) Pub. Date: Sep. 6, 2007

(54) RFID TAG WITH ANTENNA AND SENSE CONDUCTOR

(75) Inventor: Albertus Jacobus Pretorius, Pretoria (ZA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: IPICO INNOVATION INC., Aurora (CA)

(21) Appl. No.: 11/681,087

(22) Filed: Mar. 1, 2007

(30) Foreign Application Priority Data
Mar. 3, 2006 (ZA) 2006/01841

(51) Int. Cl. G08B 13/14

(52) U.S. Cl. 340/572.8

(57) ABSTRACT

A radio frequency identification (RFID) system and more particularly a tag comprising a transponder forming parts of such a system. The tag preferably includes a substrate; a transponder mounted on the substrate; the transponder comprising electronic circuitry and an antenna connected to the circuitry; a sense element on the substrate which is sensitive to damage to the substrate and which is connected to a sense input of the circuitry; the antenna comprising a metal layer and the sense element a layer of conductive ink.

### INTRODUCTION AND BACKGROUND

This invention relates to radio frequency identification systems (RFID) systems and more particularly to a tag comprising a transponder forming part of such a system.

RF transponder tags comprising a so-called “trip-wire” connected to the transponder on the tag are known. The trip-wire is normally in the form of a closed loop, connected to a sense input of an electronic circuit chip of the transponder and operates as a two state sensor. While the loop is continuous, the loop resistance is low and the sensor has a first state. However, when the loop is interrupted or damaged, the resistance increases and the sensor has a second state. The transponder circuitry is sensitive to these states. A controller forming part of the circuitry is configured to cause the circuitry to transmit via a transponder antenna, a first string of data while the loop is continuous and to transmit a second string of data when the loop is damaged or interrupted, which is normally indicative that the substrate and/or tag have been tampered with.

However, in the known tags, both the antenna and the conductive loop are formed in a conductive ink printing process. The main disadvantage of this tag is that the antenna is also susceptible to damage as aforesaid, which impairs the antenna characteristics and hence operation of the transponder.

### OBJECT OF THE INVENTION

Accordingly, it is an object of the present invention to provide an alternative tag, RFID system and method of producing a tag, with which the applicant believes the aforementioned disadvantage may at least be alleviated.

### SUMMARY OF THE INVENTION

According to the invention there is provided a tag for a radio frequency identification system, the tag comprising:
a substrate;
a transponder mounted on the substrate;
the transponder comprising electronic circuitry and an antenna connected to the circuitry;
a sense element on the substrate which is sensitive to damage to the substrate and which is connected to a sense input of the circuitry;
the antenna comprising a metal layer and the sense element a layer of conductive ink.

The sense element may be in the form of a loop.

The circuitry may be integrated on a single chip.

The circuitry may comprise a controller sensitive to whether the element is in a first low resistance state or in a second higher resistance state and operative to generate a first string of data when the element is in the first state and a second string of data when the element is in the second state.

The second string of data may be a one's complement of the first string of data.

The antenna, chip and sense element may be located in substantially the same plane.

The antenna may be formed by a first process which may comprise at least one of a metal depositing, plating, etching or similar process.

The element may be formed by a second process which may comprise a conductive ink printing process.

Also included within the scope of the present invention is an RFID system comprising a reader and at least one tag as herein defined or described.

Still further included within the scope of the present invention is a method of forming an RFID tag, the method comprising the steps of:
forming a conductive antenna for transponder circuitry on a substrate, utilizing a first process; and
forming a sense element on the substrate that is sensitive to damage to the substrate, utilizing a second process.

The first process is preferably different from the second process. The first process may comprise at least one of a metal depositing, plating, etching or similar process.

The second process may be a conductive ink printing process.

### BRIEF DESCRIPTION OF THE ACCOMPANYING DIAGRAMS

The invention will now further be described, by way of example only, with reference to the accompanying diagrams wherein:

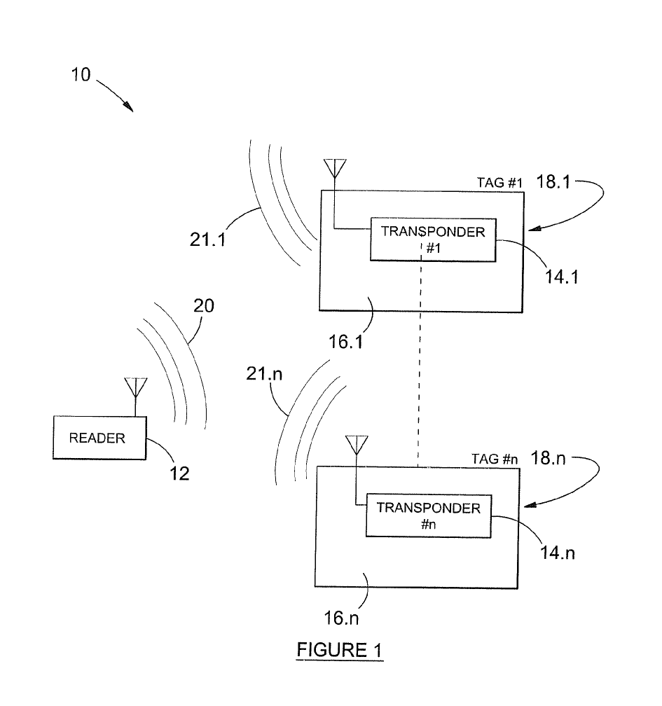

FIG. 1 is a basic block diagram of a radio frequency identification system comprising at least one tag according to the invention;

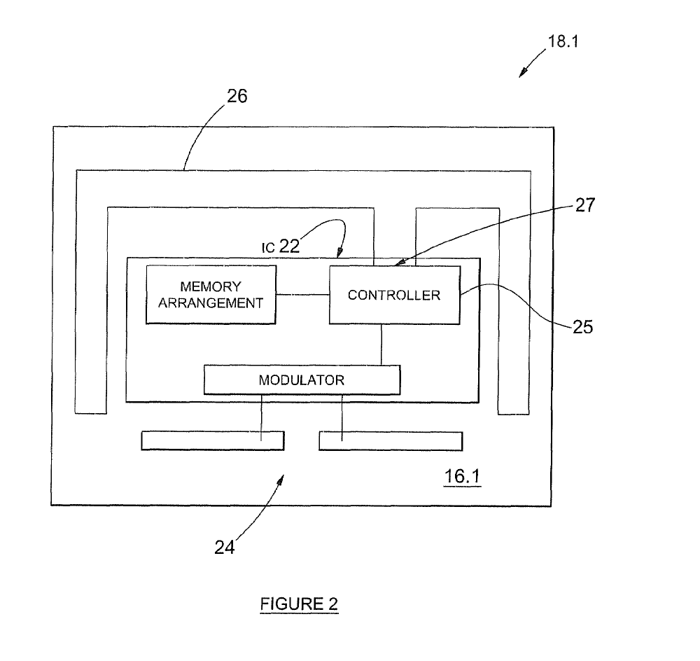

FIG. 2 is a plan view of the tag according to the invention; and

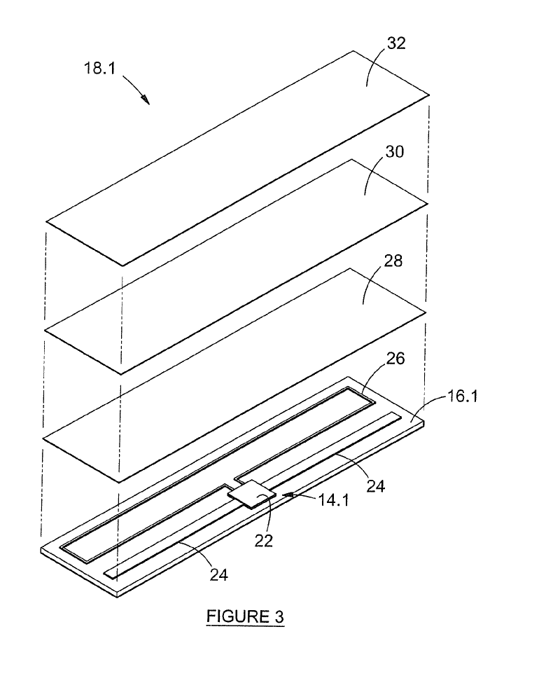

FIG. 3 is an exploded perspective view of the tag according to the invention.

### DESCRIPTION OF A PREFERRED EMBODIMENT OF THE INVENTION

An electronic radio frequency identification (RFID) system is generally designated by the reference numeral 10 in FIG. 1.

The system comprises a reader 12 and a plurality of transponders 14.1 to 14.n, each mounted on a respective substrate 16.1 to 16.n, to form a respective tag 18.1 to 18.n. In use, the reader broadcasts in known manner an energizing signal 20. The transponders 14.1 to 14.n derive electrical power from the signal and each transmits respective response signals 21.1 to 21.n comprising the response data according to one of many known protocols. The response signals comprising the response data is received by the reader and analysed, to identify and/or count host articles (not shown) carrying the transponders.

In some applications, for example where RFID tags are used as or on electronic number plates or licence discs for vehicles, it became desirable to be able electronically to sense if the tag has been tampered with. This sensing is performed by a trip or sense wire on the tag substrate and which is referred to in the introduction of this specification. The main disadvantage of the presently known tags is also set out in the introduction of this specification.

According to the present invention, an RFID tag 18.1 comprises a substrate 16.1, a transponder 14.1 comprising electronic circuitry 22 and at least one antenna 24 connected to the circuitry. The antenna is formed on the substrate by a first process and comprises a layer of metal, such as aluminium. The first process may comprise one of a metal depositing, plating, etching or a similar process. The electronic circuitry comprises a controller 25. A sense element in the form of a conductive loop 26 is connected to a sense input 27 of the controller 25. The loop is formed on the substrate by a second process. For example, the loop may be printed on the substrate 16.1 utilizing a suitable conductive ink, and is configured such that if the substrate is tampered with, the loop is damaged. The loop 26 is configured to cover a substantial part of the substrate 16.1. The circuitry is integrated on a single chip 22, and the chip 22, antenna 24 and loop 26 are all located in substantially the same plane on the substrate 16.1.

Referring now to FIG. 3, a protective layer 28 is provided on the substrate, to sandwich the chip 22, antenna 24 and loop 26 between the substrate 16.1 and the protective layer 28. A layer of glue 30 is provided on the protective layer 28. A peel off layer 32 is provided on the layer of glue 30, to protect the layer of glue.

In use, the tag is preferably mounted on an outside of a windscreen (not shown) of a motor vehicle (also not shown). In order to do this, the peel off layer 32 is removed and the tag is mounted on the window with the exposed layer of glue 30 immediately adjacent the window and the substrate 16.1 furthest away therefrom. In some applications suitable printed matter may be provided on an outer and then outwardly exposed face of the substrate.

While the substrate remains undisturbed, the loop 26 is continuous having a low resistance, resulting in a first electronically detectable state. However, should it be attempted to remove the tag by the substrate from the window, the substrate is necessarily tampered with, which causes damage to the loop and which results in a second electronically detectable state. While energized, the controller 25 of the circuitry 22 senses the state of the loop via sense input 27.

While the loop is in the first continuous state, a first string of response data is caused by the controller to be transmitted to the reader 12, as aforesaid. However, if the loop is in the second state, the controller 25 causes a second string of response data to be transmitted. The second string of response data may be the one's complement of the first string of response data.

With the tag according to the invention, it is believed that the characteristics of the metal antenna would not severely be impaired during attempted tampering with the substrate and that the tag will still be able to transmit the second string of data successfully to a reader.

1. A tag for a radio frequency identification system, the tag comprising:
a substrate;
a transponder mounted on the substrate;
the transponder comprising electronic circuitry and an antenna connected to the circuitry;
a sense element on the substrate which is sensitive to damage to the substrate and which element is connected to a sense input of the circuitry;
the antenna comprising a metal layer and the sense element a layer of conductive ink.

2. A tag as claimed in claim 1 wherein the sense element comprises a loop.

3. A tag as claimed in claim 1 wherein the circuitry is integrated on a single chip.

4. A tag as claimed in claim 1 wherein the circuitry comprises a controller sensitive to whether the sense element is in a first low resistance state or in a second higher resistance state and operative to generate a first string of data when the element is in the first state and a second string of data when the element is in the second state.

5. A tag as claimed in claim 4 wherein the second string of data is the one's complement of the first string of data.

6. A tag as claimed in claim 1 wherein the antenna, chip and sense element are located in substantially the same plane.

7. A tag as claimed in claim 1 wherein the antenna is formed by a first process comprising one of a metal depositing, plating, etching or similar process.

8. A tag as claimed in claim 7 wherein the element is formed by a second process comprising a conductive ink printing process.

9. An RFID system comprising a reader and at least one tag as claimed in claim 1.

10. A method of forming an RFID tag, the method comprising the steps of:
forming a conductive antenna for transponder circuitry on a substrate, utilizing a first process; and
forming a sense element on the substrate that is sensitive to damage to the substrate, utilizing a second process.

11. A method as claimed in claim 10 wherein the first process is different from the second process.

12. A method as claimed in claim 11 wherein the first process comprises at least one of a metal depositing, plating, etching or similar process.

13. A method as claimed in claim 11 wherein the second process comprises a conductive ink printing process.
